(19) United States
(12) Patent Application Publication
(10) Pub. No.: US 2021/0168200 A1
(43) Pub. Date: Jun. 3, 2021

(54) DEVICE MANAGEMENT SYSTEM, DEVICE MANAGEMENT APPARATUS, AND NETWORK SYSTEM

(71) Applicant: Satoru HIRAKATA, Tokyo (JP)

(72) Inventor: Satoru HIRAKATA, Tokyo (JP)

(73) Assignee: Ricoh Company, Ltd., Tokyo (JP)

(21) Appl. No.: 17/080,000

(22) Filed: Oct. 26, 2020

(30) Foreign Application Priority Data
Nov. 28, 2019 (JP) 2019-215424

(51) Int. Cl. H04L 29/08; H04L 29/06; G06F 21/10; G06F 21/12

(52) U.S. Cl. CPC H04L 67/107; H04L 67/1097; G06F 21/123; H04L 63/08; G06F 21/105; H04L 63/10

(57) ABSTRACT

A device management system, a device management apparatus, and a network system. The device management system receives device identification information for identifying a device transmitted from the device through a communication network, acquires application identification information for identifying an application identified based on tenant information associated with the received device identification information, and transmits the application identification information to the device as identification information of the application to be installed on the device.

### CROSS-REFERENCE TO RELATED APPLICATIONS

This patent application is based on and claims priority pursuant to 35 U.S.C. § 119(a) to Japanese Patent Application No. 2019-215424, filed on Nov. 28, 2019 in the Japan Patent Office, the entire disclosure of which is hereby incorporated by reference herein.

### BACKGROUND

### Technical Field

The present disclosure relates to a device management system, a device management apparatus, and a network system.

### Background Art

In recent years, there has been an increase in service provision forms in which users use only necessary functions when necessary. Software as a service (SaaS), which is a form of software usage that allows user to freely select and use the necessary function, a combination of computing resources on the internet, cloud computing that provides high-value-added services to end users, and the like are examples of such service provision forms.

Further, a system that remotely manages devices residing on a local network such as a local area network (LAN) from outside the local network is known. In such system, for example, remote management of devices is implemented by communicating between a device residing in the local network and a device management system located outside the local network.

Furthermore, a technique that links a device to a tenant for each customer who owns the device, and an operator such as a user or a customer engineer (CE) gives an application installation instruction to the device to install the desired application is known. For example, a method to configure settings when the same application is installed on multiple devices or to change settings after uninstalling the application through a network such as the internet is disclosed.

However, with the conventional method, in order to install the desired application on the device, the operator must manually select the application to he installed, which takes time and effort.

### SUMMARY

Embodiments of the present disclosure describe a device management system, a device management apparatus, and a network system. The device management system receives device identification information for identifying a device transmitted from the device through a. communication network, acquires application identification information for identifying an application identified based on tenant information associated with the received device identification information, and transmits the application identification information to the device as identification information of the application to be installed on the device.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a diagram illustrating an example of a system configuration of a network system, according to embodiments of the present disclosure;

FIG. 2 is a diagram illustrating an example of an outline of the network system, according to embodiments of the present disclosure;

FIG. 3 is a block diagram illustrating an example of a hardware configuration of each device included in the network system according to embodiments of the present disclosure;

FIG. 4 is a block diagram illustrating an example of a functional configuration of a device according to embodiments of the present disclosure;

FIG. 5 is a block diagram illustrating an example of a functional configuration of the network system according to embodiments of the present disclosure;

FIG. 6 is a block diagram illustrating an example of the functional configuration of the network system according to embodiments of the present disclosure;

FIG. 7A is a conceptual diagram illustrating an example of an authentication management table according to embodiments of the present disclosure;

FIG. 7B is a conceptual diagram illustrating an example of a system management table according to embodiments of the present disclosure;

FIG. 8A is a conceptual diagram illustrating an example of a device information management table according to embodiments of the present disclosure;

FIG. 8B is a conceptual diagram illustrating an example of a customer information management table according to embodiments of the present disclosure;

FIG. 9 is a conceptual diagram illustrating an example of an application management table according to embodiments of the present disclosure;

FIG. 10 is a sequence diagram illustrating an example of an installation process of an external application when a device is registered in the network system according to embodiments of the present disclosure;

FIG. 11 is a sequence diagram illustrating an example of the installation process of the external application when the device is registered in the network system according to embodiments of the present disclosure;

FIG. 12 is a sequence diagram illustrating an example of the installation process of the external application when the device is not registered in the network system, according to embodiments of the present disclosure; and

FIG. 13 is a sequence diagram illustrating an example of the installation process of the external application when the device is not registered in the network system, according to embodiments of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. As used herein, the singular forms “a”, “an”, and “the” are intended to include the plural forms as well, unless the context clearly indicates otherwise.

Embodiments of the present disclosure are described with reference to the drawings. In the description of the drawings, the same elements are denoted by the same reference numerals, and redundant description is omitted.

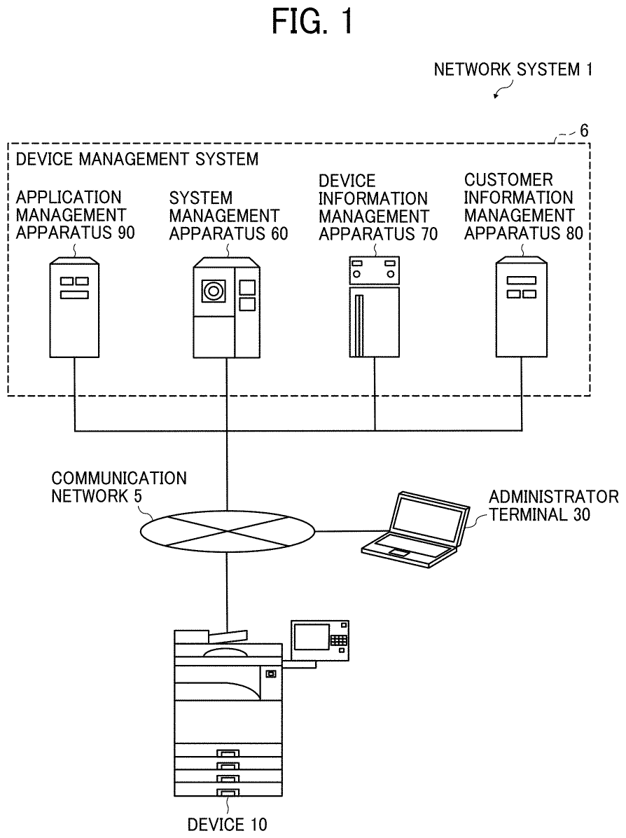

FIG. 1 is a diagram illustrating an example of a system configuration of a network system, according to the present embodiment. The network system 1 illustrated in FIG. 1 is a system in which a device management system 6 on the cloud and a cloud integration application 170, each of which is described below, installed in the device 10 operate in cooperation with each other.

The network system 1 includes a device 10, an administrator terminal 30, and a device management system 6. The device 10 and the administrator terminal 30 are connected to the device management system 6 through the communication network 5. The communication network 5 is implemented by the internet, mobile communication network, local area network (LAN), and the like. The communication network 5 includes not only wired communication but may also include networks by wireless communication such as 3rd generation (3G), 4th generation (4G), 5th generation (5G), Wireless Fidelity (registered trademark) (Wi-Fi), and Worldwide Interoperability for Microwave Access (WiMAX) or Long Term Evolution (LTE). Further, the communication network 5 may include a network implemented by a blockchain.

The device 10 is a device that resides on the local network and is managed by the device management system 6. A local network is formed in a network environment at a customer's site such as an office, a conference room, a warehouse, a factory or a production line. The local network is, for example, an in-house LAN that does not go through the internet. The device 10 is, for example, an image forming apparatus such as a multi-function peripheral (MFP). The image forming apparatus may be a portable handy printer, a handy scanner, or the like, as well as an apparatus installed at a specific place by an administrator or a user. The device 10 is not limited to an image forming apparatus and examples thereof may include, for example, a three-dimensional (3D) printer (three-dimensional modeling device), a. projector, an interactive white board (IWB; an electronic whiteboard capable of intercommunication), and a video conference terminal, an output device such as a digital signage, a head up display (HUD) device, an acoustic output device such as a speaker, an autonomous traveling robot, or a telepresence robot. Further, examples of the device 10 include an industrial machine such as a processing device, an inspection device, a transport device or a picking device, a photographing device such as a digital camera, a sound collecting device, a medical device, a network home appliance, a vending machine, a power supply device, an air conditioning system, and a measuring system such as gas, water or electricity. Furthermore, examples of the device 10 include a personal computer (PC), a mobile phone, a smartphone, a tablet terminal, a game machine, a personal digital assistant (PDA), a wearable terminal, and the like.

The administrator terminal 30 is a terminal such as a notebook PC used by the administrator of the device 10. The administrator terminal 30 uses a web browser or a software application to input various contract information and the like. The administrator terminal 30 may be, for example, a tablet terminal, a mobile phone, a smartphone, a wearable terminal, a desktop PC, or the like.

The device management system 6 is a system for managing the device 10 residing in the local network. The device management system 6 communicates with the device 10 residing in the local network through the communication network 5. The device management system 6 includes a system management apparatus 60, a device information management apparatus 70, a customer information management apparatus 80, and an application management apparatus 90. In the device management system 6, the apparatuses described above are operating in cooperation with each other on the cloud.

The system management apparatus 60 is a server computer that manages the entire operation of the device management system 6 including an authentication process for the device 10. A tenant has conventionally indicated a renter of land or room, but on the internet, the tenant indicates a customer who uses resources in a system on the cloud for a fee or free of charge. The tenant is, for example, an organization such as a company, a department, or a group, and is sometimes called organization information. In addition, the tenant is assigned on an organizational basis and become a billing or contract unit.

The device information management apparatus 70 is a server computer that manages the device 10 associated with the tenant. The device information management apparatus 70 stores and manages device information for each device 10 registered in the device management system 6. The customer information management apparatus 80 is a server computer that manages contract information indicating contract details for each customer. The application management apparatus 90 is a server computer that manages application published in the network system 1.

The system management apparatus 60, the device information management apparatus 70, the customer information management apparatus 80, and the application management apparatus 90 may each be implemented by a single server computer, or any part (function) of any apparatus may be divided into a plurality of sections to be distributed over a plurality of server computers. Further, the device management system 6 may be implemented by a single computer including each part (function) of the system management apparatus 60, the device information management apparatus 70, the customer information management apparatus 80, and the application management apparatus 90.

FIG. 1 illustrates an example in which one device 10 is managed by the device management system 6, but the device management system 6 may be configured to manage a plurality of devices 10. In this case, the device management system 6 may be configured to manage a plurality of devices 10 in one local network or may be configured to manage devices 10 in different local networks.

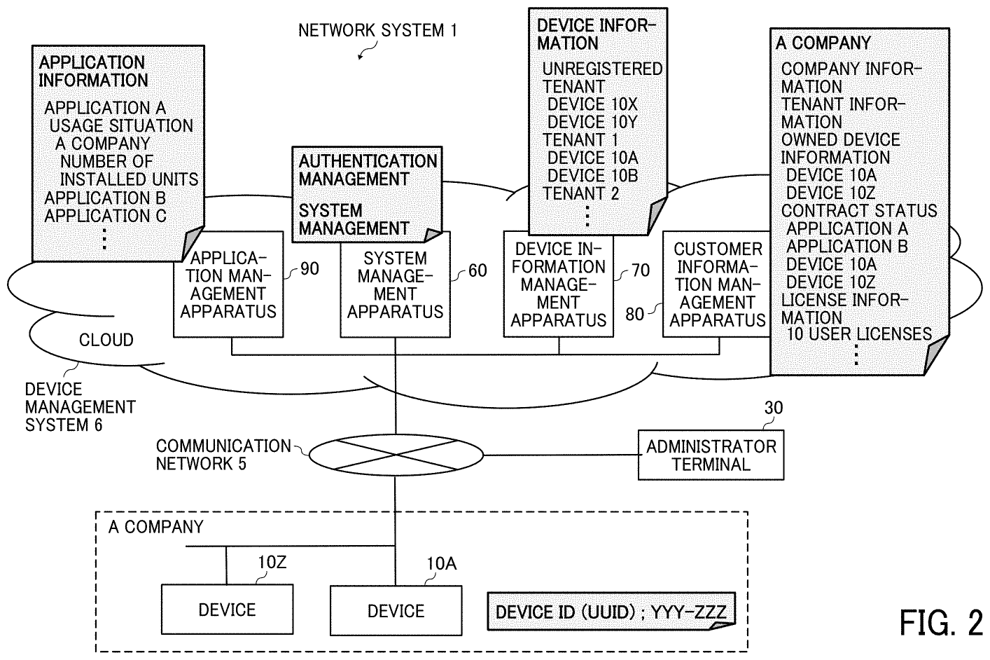

An outline of the network system according to the present embodiment is described. Note that FIG. 2 briefly describes the outline of the network system according to the present embodiment, and details of the functions and the like implemented by the network system 1 is described below with reference to the drawings.

FIG. 2 is a diagram illustrating an example of the outline of the network system, according to the present embodiment. In the network system 1, the apparatuses included in the device management system 6 on the cloud execute respective functions of customer management, device management, and application management, and operate in cooperation with each other.

The system management apparatus 60 manages the operation of the entire system and has functions such as authentication management in the device management system 6. The device information management apparatus 70 manages device information of the device 10 residing in the network system 1. Further, the device information management apparatus 70 determines whether or not the device 10 is registered in the device information management apparatus 70 based on the device information for each device 10 and manages tenant information assigned to the customer who owns the registered device 10. The customer information management apparatus 80 manages contract information for each customer. The application management apparatus 90 manages application information which is information about an application published in the network system 1. The application information includes usage information such as the number of installations for each application.

In the example of FIG. 2, a customer company A owns a device 10A and a device 10Z connected to the local network in the company A. The device 10A and the device 10Z respectively have a cloud integration application 170, which is an application that cooperates with the device management system 6 on the cloud. The device 10.A and the device 10Z transmit a device identifier (ID) unique to the device 10 to the device management system 6 by operating the cloud integration application 170. For example, the device 10A transmits the device ID (UUID (Universally Unique Identifier)) “YYY-ZZZ” to the device management system 6 through the communication network 5.

The device management system 6 identifies the tenant assigned to the company A that owns the device 10A registered in the device information management apparatus 70, based on the device ID transmitted from the device 10A. Further, the device management system 6 identities the contract information of the company A associated with the identified tenant among the customer information registered in the customer information management apparatus 80. Then, the device management system 6 transmits the identified contract information to the device 10A through the communication network 5.

The device 10A that has received the contract information transmits a request for acquiring information about the application to be installed, indicated by the contract information, to the application management apparatus 90 included in the device management system 6 through the communication network 5. Then, the device 10A executes installation of the application corresponding to an application ID transmitted from the application management apparatus 90.

Further, when the device 10 is not registered in the device management system 6, the network system 1 registers the contract information of the customer who owns the device 10 by using the administrator terminal 30 used by the administrator of the device 10. In this case, the device management system 6 causes the device 10 to install the desired application as described above based on the contract information registered using the administrator terminal 30. As a result, the device 10A identifies the tenant associated with the device ID without explicitly inputting the registered information such as the tenant and installs the application based on the contract information associated with the identified tenant.

Conventionally, in order to install a desired application to a device when installing the device, an operator such a user or a customer engineer is required to input the tenant information and an account for linking the device and the tenant. The operator has to prepare the tenant information, account information, and the like, and. explicitly perform the registration work. Further, even for the contracted application, the desired application could not be installed unless the operator explicitly instructed the installation.

The network system 1 manages the device identification information (device ID) and the contract information such as purchase history of the device 10 and the application associated with each other in the device management system 6 on the cloud. The operator is not required to manually associate (register) the device 10 with the customer's tenant when installing the device 10, and the contracted application can be automatically installed on the device 10. As a result, the network system I can reduce cost, workload, and the like otherwise required when installing the device or installing the application.

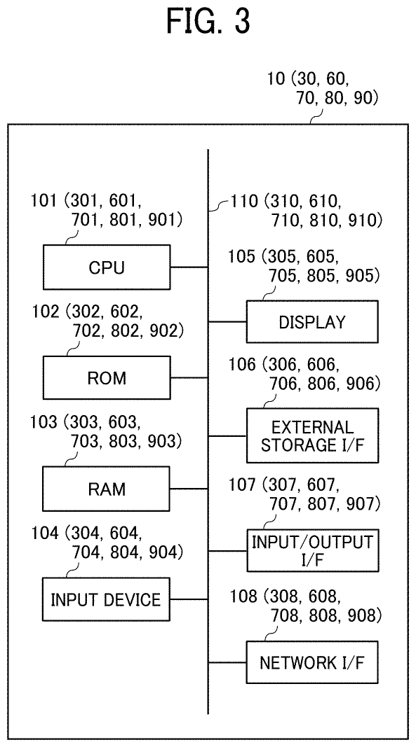

A hardware configuration of each device illustrated in FIG. 1 is described with reference to FIG. 3. In the hardware configuration illustrated in FIG. 3, components or elements may be added or deleted as needed. FIG. 3 is a diagram illustrating an example of the hardware configuration of each device included in the network system according to the present embodiment.

A computer as an example of the device 10 includes a central processing unit (CPU) 101, a read only memory (ROM) 102, a random access memory (RAM) 103, an input device 104, a display 105, and an external storage interface WO 106, an input/output 107, and a network I/F 108.

Among the above described elements, the CPU 101 controls all operations of the device 10. The ROM 102 is a non-volatile memory that stores a program used to drive the CPU 101. The RAM 103 is a volatile memory used as a work area for the CPU 101. The input device 104 receives an operation input by a user. The input device 104 is, for example, a keyboard, a mouse, a touch panel, a button, a dial, a microphone for voice input, and the like.

The display 105 is a liquid crystal display, an organic electro luminescence (EL), or the like and displays various information such as a cursor, a menu, a window, characters, an icon, or an image. The external storage I/F 106 controls reading or writing (storage) of data to an external storage such as a storage medium. The input/output I/F 107 is an interface for connecting to an external device in order to input and output various data or information to and from various external devices. The network I/F 108 is an interface for performing data communication through the communication network 5. Further, the device 10 includes a bus line 110. The bus line 110 is an address bus, a data bus, and the like for electrically connecting each component such as the CPU 101.

The administrator terminal 30 is implemented by a general computer, and as illustrated in FIG. 3, includes the CPU 301, ROM 302, RAM 303, input device 304, display 305, external storage 1/F 306, input/output I/F 307, network I/F 308, and bus line 310. Since these elements are substantially similar to the CPU 101, ROM 102, RAM 103, input device 104, display 105, external storage I/F 106, input/output I/F 107, network I/F 108, and bus line 110 in the device 10, redundant description thereof is omitted.

The system management apparatus 60 is implemented by the general computer, and as illustrated in FIG. 3, includes the CPU 601, ROM 602, RAM 603, input device 604, display 605, external storage I/F 606, input/output UT 607, network I/F 608, and bus line 610. Since these elements are substantially similar to the CPU 101, ROM 102, RAM 103, input device 104, display 105, external storage I/F 106, input/output I/F 107, network I/F 108, and bus line 110 in the device 10, redundant description thereof is omitted.

The device information management apparatus 70 is implemented by the general computer, and as illustrated in FIG. 3, includes the CPU 701, ROM 702, RAM 703, input device 704, display 705, external storage IF 706, input/output IT 707, network I/F 708 and bus line 710. Since these elements are substantially similar to the CPU 101, ROM 102, RAM 103, input device 104, display 105, external storage I/F 106, input/output IX 107, network I/F 108, and bus line 110 in the device 10, redundant description thereof is omitted.

The customer information management apparatus 80 is implemented by the general computer, and as illustrated in FIG. 3, includes the CPU 801, ROM 802, RAM 803, input device 804, display 805, external storage I/F 806, input/output 1/F 807, network I/F 808 and bus line 810. Since these elements are substantially similar to the CPU 101, ROM 102, RAM 103, input device 104, display 105, external storage I/F 106, input/output I/F 107, network I/F 108, and bus line 110 in the device 10, redundant description thereof is omitted.

The application management apparatus 90 is implemented by the general computer, and as illustrated in FIG. 3, includes the CPU 901, ROM 902, RAM 903, input device 904, display 905, external storage IT 906, input/output I/F 907, network I/F 908. and bus line 910. Since these elements are substantially similar to the CPU 101, ROM 102, RAM 103, input device 104, display 105, external storage I/F 106, input/output 107, network I/F 108, and bus line 110 in the device 10, redundant description thereof is omitted.

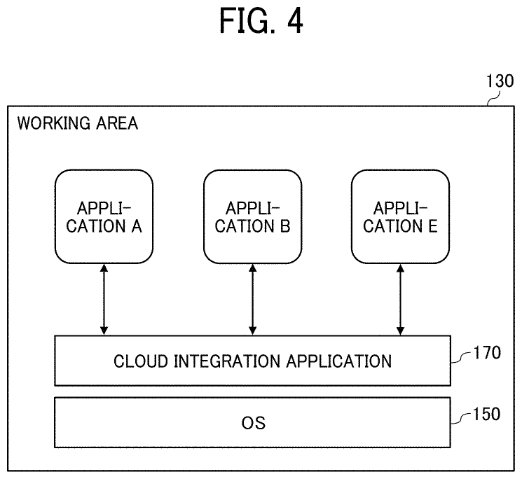

The computer software installed in the device 10 is described with reference to FIG. 4. FIG. 4 is a block diagram illustrating an example of a functional configuration of a device according to the present embodiment. As illustrated in FIG. 4, an operating system (OS) 150, cloud integration application 170, application A, application B, and application E operate on the work area 130 of the RAM 103. The OS 150 is basic software that controls entire operation of the device 10 through providing a basic function of the device 10.

The cloud integration application 170 is an application that runs on the OS 150 and cooperates with a service or a function provided by the device management system 6 on the cloud. Further, the cloud integration application 170 manages, for example, an external application.

The application A, the application B, and the application E are applications that operate on the cloud integration application 170 (hereinafter, referred to as the external application when it is not necessary to distinguish). Each external application executes processing independently and executes a service or function provided on the cloud integration application 170. FIG. 4 illustrates an example in which three external applications are installed on the device 10, but the number of external applications installed on the device 10 is not limited to three.

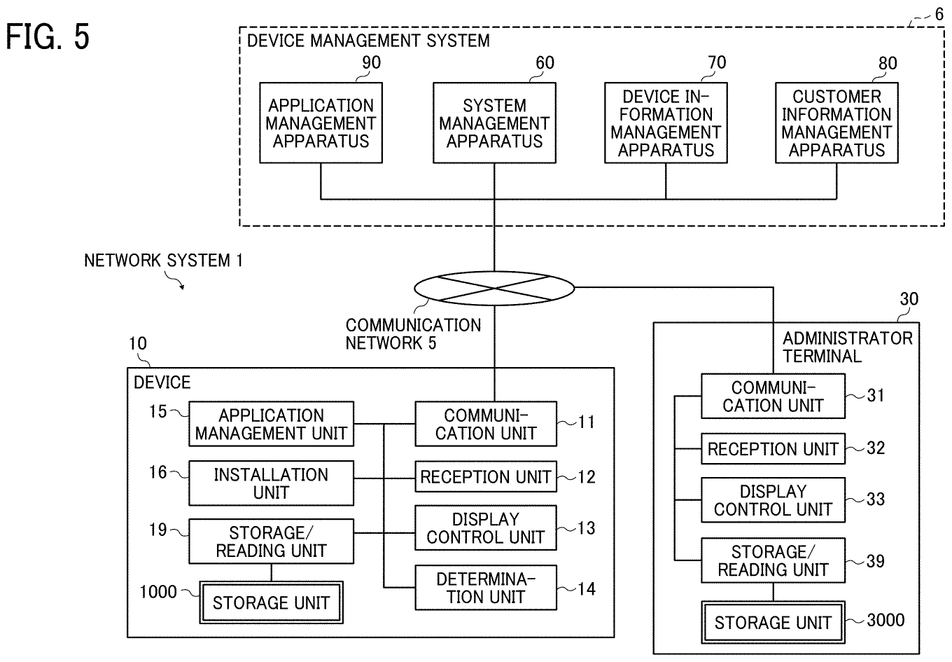

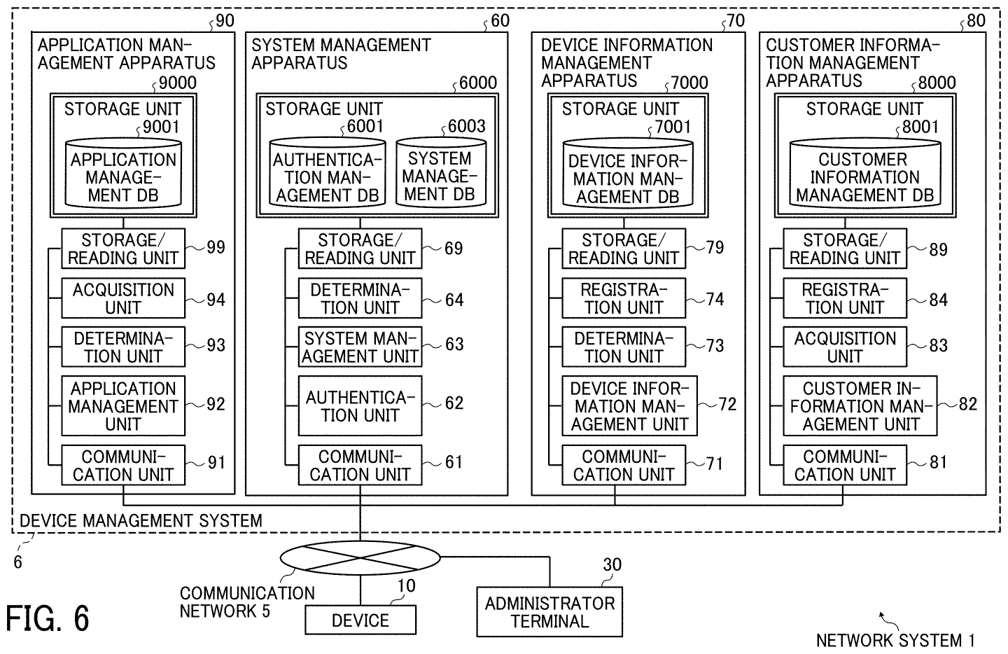

The functional configuration of the network system according to the present embodiment is described with reference to FIGS. 5 to 9. FIGS. 5 and 6 are block diagrams illustrating an example of the functional configuration of the network system according to the present embodiment. Note that FIGS. 5 and 6 illustrate functional configuration related to processing or operation described below in each of the apparatuses illustrated in FIG. 1.

A description is now given of a functional configuration of the device 10 with reference to FIG. 5. The device 10 includes a communication unit 11, a reception unit 12, a display control unit 13, a determination unit 14, an application management unit 15, an installation unit 16, and a storage/reading unit 19. These units are functions implemented by or caused to function by operating any of the elements illustrated in FIG. 3 in cooperation with the instructions of the CPU 101 according to the control program expanded from the ROM 102 to the RAM 103. Further, the device 10 includes a storage unit 1000 implemented by the ROM 102 illustrated in FIG. 3 or the external storage.

The communication unit 11 is a function implemented by instructions of the CPU 101 illustrated in FIG. 3 and the network I/F 108 and communicates various data or information with the external device. The communication unit 11 communicates with each device included in the device management system 6 through the communication network 5. The communication unit 11 transmits, for example, the authentication information for executing the cloud integration application 170 to the system management apparatus 60 through the communication network 5. Further, the communication unit 11 transmits, for example, a device ID that identifies the device 10 to the device information management apparatus 70 through the communication network 5.

The reception unit 12 is a function implemented by instructions of the CPU 101 and the input device 104 illustrated in FIG, 3 and accepts various input operations from the user. The display control unit 13 is implemented by instructions of the CPU 101 illustrated in FIG. 3 and the display 105 and displays various screens such as an operation screen that accepts input operations by the user on the display 105. The display control unit 13 uses. for example, a web browser to display a web page created by HyperText Markup Language (HTML) or the like on the display 105. The determination unit 14 is a function implemented by instructions of the CPU 101 illustrated in FIG. 3 and performs various determinations.

The application management unit 15 is a function implemented by instructions of the CPU 101 illustrated in FIG. 3 and manages the external application installed on the device 10. The installation unit 16 is a function implemented by instructions of the CPU 101 illustrated in FIG. 3 and causes the device 10 to install the external application. The installation unit 16 installs, for example, the external application identified by the application ID received by the communication unit 11 on the cloud integration application 170.

The storage/reading unit 19 is a function implemented by instructions of the CPU 101 illustrated in FIG. 3 to store various data in the storage unit 1000 or read various data from the storage unit 1000.

A functional configuration of the administrator terminal 30 is described with reference to FIG. 5. The administrator terminal 30 includes a communication unit 31, a reception unit 32, a display control unit 33, and a storage/reading unit 39. These units are functions implemented by or caused to function by operating any of the hardware elements illustrated in FIG. 3 in cooperation with the instructions of the CPU 301 according to the control program expanded from the ROM 302 to the RAM 303. In addition, the administrator terminal 30 includes a storage unit 3000 implemented by the ROM 302 illustrated in FIG. 3 or an external storage.

The communication unit 31 is a function implemented by instructions of the CPU 301 illustrated in FIG. 3 and the network I/F 308 and communicates various data or information with the external device. For example, the communication unit 11 transmits the contract information of the device 10 input by the administrator and received by the reception unit 32 to each apparatus included in the device management system 6 through the communication network 5.

The reception unit 32 is a function implemented by instructions of the CPU 301 and the input device 304 illustrated in FIG. 3 and accepts various input operations from the user. The display control unit 33 is a function implemented by instructions of the CPU 301 illustrated in FIG. 3 and the display 305 and causes the display 305 to display various screens such as an operation screen that accepts the input operation by the user. The display control unit 33 uses, for example, a web browser to display a web page created by I-ITML or the like on the display 305.

The storage/reading unit 39 is implemented by instructions of the CPU 301 illustrated in FIG. 3 and stores various data in the storage unit 3000 and reads various data from the storage unit 3000.

A functional configuration of the system management apparatus 60 is described with reference to FIG. 6. The system management apparatus 60 includes a communication unit 61, an authentication unit 62, a system management unit 63, a. determination unit 64, and a storage/reading unit 69. These units are functions implemented by or caused to function by operating any of the hardware elements illustrated in FIG. 3 in cooperation with the instructions of the CPU 601 according to the control program expanded from the ROM 602 to the RAM 603. Further, the system management apparatus 60 includes a storage unit 6000 implemented by the ROM 602 illustrated in FIG. 3 or the external storage.

The communication unit 61 is a function implemented by instructions of the CPU 601 illustrated in FIG. 3 and the network I/F 608 and communicates various data or information with the external device. The communication unit 61 receives, for example, the authentication request transmitted from the device 10 through the communication network 5. Further, the communication unit 61 transmits, for example, result of authentication by the authentication unit 62 to the device 10 through the communication network 5.

The authentication unit 62 is a function implemented by instructions of the CPU 601 illustrated in FIG. 3 and authenticates the device 10 based on the authentication request received by the communication unit 61. The authentication unit 62 searches an authentication management database (DB) 6001 using, for example, the device ID and password included in the authentication request received by the communication unit 61 as search keys. Then, the authentication unit 62 authenticates the device by determining whether the same set of device ID and password are managed in the authentication management DB 6001.

The system management unit 63 is a function implemented by instructions of the CPU 601 illustrated in FIG. 3 and manages each apparatus on the cloud including the device management system 6. The determination unit 64 is a function implemented by instructions of the CPU 601 illustrated in FIG. 3 and performs various determinations.

The storage/reading unit 69 is implemented by instructions of the CPU 601 illustrated in FIG, 3 and stores various data in the storage unit 6000 and reads various data from the storage unit 6000.

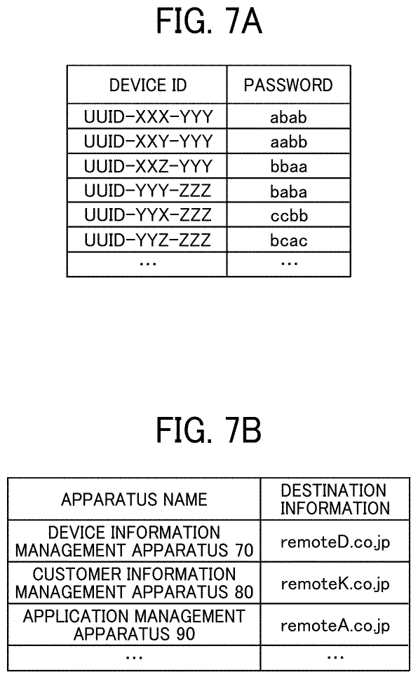

FIG. 7A is a conceptual diagram illustrating an example of an authentication management table according to the present embodiment. In the storage unit 6000, the authentication management DB 6001 storing an authentication management table as illustrated in FIG. 7A is implemented. In the authentication management table, each password is associated and managed for each terminal ID of all the devices 10 managed by the system management apparatus 60. The device ID is identification information uniquely assigned to each device 10 such as QUID or Globally Unique Identifier (QUID). In the authentication management table illustrated in FIG. 7A, the QUID of the device 10 (for example, the device 10A) is “XXX-YYY” and the password is “abab”.

FIG. 7B is a conceptual diagram illustrating an example of a system management table according to the present embodiment. The storage unit 6000 stores a system management DB 6003, Which is implemented by the system management table as illustrated in FIG. 7B. In the system management table, server information indicating each device included in the device management system 6 is stored and managed. The server information includes an apparatus name (server name) that identifies the apparatus included in the device management system 6 and destination information indicating the destination of the apparatus. In the system management table illustrated in FIG. 7B, the server information of the device information management apparatus 70, the customer information management apparatus 80, and the application management apparatus 90 included in the device management system 6 as illustrated in FIG. 1 are indicated. In the system management table illustrated in FIG. 7B, the destination information of the device information management apparatus 70 is “remoteD.co.jp”, and the destination information of the customer information management apparatus 80 is “remoteK.co.jp”, and the destination information of the application management apparatus 90 is “remoteA.co.jp”.

A functional configuration of the device information management apparatus 70 is described below with reference to FIG. 6. The device information management apparatus 70 includes a communication unit 71, a device information management unit 72, a determination unit 73, a registration unit 74, and a storage/reading unit 79. These units are functions implemented by or caused to function by operating any of the elements illustrated in FIG. 3 in cooperation with instructions of the CPU 701 according to the control program expanded from the ROM 702 to the RAM 703. Further, the device information management apparatus 70 includes a storage unit 7000 implemented by the ROM 702 illustrated in FIG. 3 or the external storage.

The communication unit 71 is a function implemented by instructions of the CPU 701 illustrated in FIG. 3 and the network I/F 708 and communicates various data or information with the external device. The communication unit 71 receives, for example, the device ID transmitted from the device 10 through the communication network 5. Further, the communication unit 71 transmits, for example, the contract information of the device 10 corresponding to the received device If) to the customer information management apparatus 80.

The device information management unit 72 is a function implemented by instructions of the CPU 701 illustrated in FIG. 3 and manages device information of the device 10 included in the network system 1. The device information management unit 72 manages, for example, the device information of the device 10 registered in the device management system 6. The determination unit 73 is a function implemented by instructions of the CPU 701 illustrated in FIG. 3 and performs various determinations. The determination unit 73 determines whether or not the device 10 is registered in the device management system 6, for example, according to whether the tenant information corresponding to the device 10 is registered in a device information management DB 7001.

The registration unit 74 is a function implemented by instructions of the CPU 701 illustrated in FIG. 3 and registers the device information of the device 10 in the device information management DB 7001 of the device management system 6. For example, when the contract information transmitted from the customer information management apparatus 80 is received by the communication unit 71, the registration unit 74 registers the tenant information included in the received contract information in the device information management DB 7001 as the device information.

The storage/reading unit 79 is a function implemented by instructions of the CPU 701 illustrated in FIG. 3 and stores various data in the storage unit 7000 or read various data from the storage unit 7000.

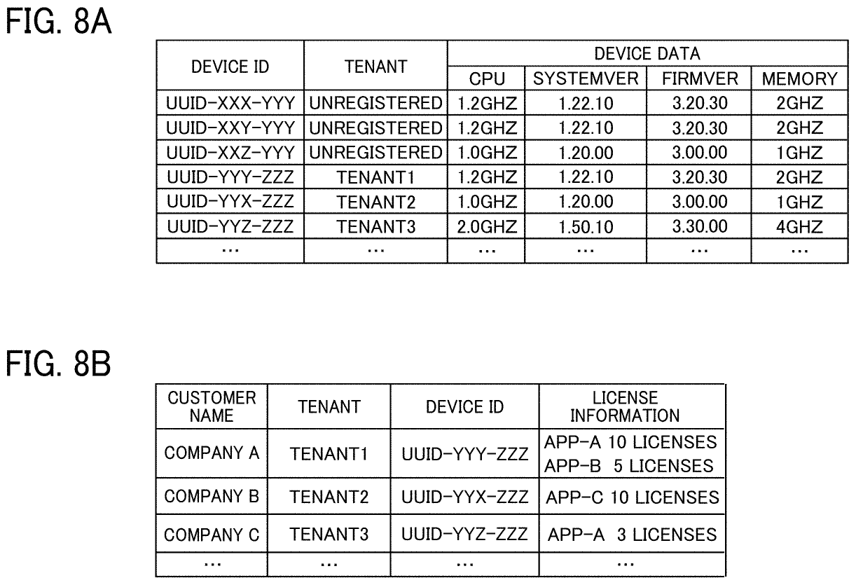

FIG. 8A is a conceptual diagram illustrating an example of a device information management table according to the present embodiment. In the storage unit 7000, the device information management DB 7001 storing a device information management table as illustrated in FIG. 8A. is implemented, in the device information management table, the device information of the device 10 registered in the device management system 6 is stored and managed. The device information is associated with the tenant information indicating the tenant to which the device 10 belongs and device data indicating operating state or performance of the device 10 for each device ID of the device 10. The device data includes CPU capacity, version of the linked device management system 6, firmware version, memory capacity, and the like. Further, “Unregistered” is indicated for a device 10 when a tenant is not registered in the device management system 6.

A functional configuration of the customer information management apparatus 80 is described below with reference to FIG. 6. The customer information management apparatus 80 includes a communication unit 81, a customer information management unit 82, an acquisition unit 83, a registration unit 84, and a storage/reading unit 89. These units are functions implemented by or caused to function by operating any of the elements illustrated in FIG. 3 in cooperation with instructions of the CPU 801 according to the control program expanded to the RAM 803. Further, the customer information management apparatus 80 includes a storage unit 8000 implemented by the ROM 802 illustrated in FIG. 3 or the external storage.

The communication unit 81 is a function implemented by instructions of the CPU 801 illustrated in FIG. 3 and the network I/F 808 and communicates various data or information with the external device. The communication unit 81 receives, for example, the device ID transmitted from the device information management apparatus 70. Further, the communication unit 81 transmits, for example, the contract information of the customer that owns the device 10 corresponding to the received device ID to the device information management apparatus 70.

The customer information management unit 82 is a function implemented by instructions of the CPU 801 illustrated in FIG. 3 and manages contract information of the device 10 included in the network system 1 for each customer. The customer information management unit 82 manages the contract information of the customer who owns the device 10 registered in the device management system 6, for example, by using a customer information management DB 8001.

The acquisition unit 83 is a function implemented by instructions of the CPU 801 illustrated in FIG. 3 and acquires the tenant information indicating the tenant assigned to each customer who owns the device 10. For example, when the contract information transmitted from the administrator terminal 30 is received by the communication unit 81, the acquisition unit 83 acquires the tenant information to be assigned to the customer corresponding to the received contract information. The registration unit 84 is a function implemented by instructions of the CPU 801 illustrated in FIG. 3 and registers the contract information of the customer who owns the device 10 to be registered in the device management system 6 as the customer information. For example, when the contract information transmitted from the administrator terminal 30 is received by the communication unit 81, the registration unit 84 registers the received contract information in a customer information management DB 8001.

The storage/reading unit 89 is a function implemented by instructions of the CPU 801 illustrated in FIG. 3 and stores various data in the storage unit 8000 or read various data from the storage unit 8000.

FIG. 8B is a conceptual diagram illustrating an example of a customer information management table according to the present embodiment. In the storage unit 8000, the customer information management DB 8001 storing a customer information management table as illustrated in FIG. 8B is implemented. In the customer information management table, contract information indicating contract details for each customer is stored. The contract information for each customer includes a customer name, tenant information indicating the tenant assigned to each customer, the device ID for identifying the device 10 owned by the customer, and license information indicating a license granted to the customer for the external application.

A functional configuration of the application management apparatus 90 is described below with reference to FIG, 6. The application management apparatus 90 includes a communication unit 91, an application management unit 92, a determination unit 93, an acquisition unit 94, and a storage/reading unit 99. These units are functions implemented by or caused to function by operating any of the elements illustrated in FIG. 3 in cooperation with instructions of the CPU 901 according to the control program expanded to the RAM 903. Further, the application management apparatus 90 includes a storage unit 9000 implemented by the ROM 902 illustrated in FIG. 3 or the external storage.

The communication unit 91 is a function implemented by instructions of the CPU 901 illustrated in FIG. 3 and the network I/F 908 and communicates various data or information with the external device. The communication unit 91 receives, for example, an application acquisition request from the device 10 for requesting information on the external application to be installed on the device 10 through the communication network 5. Further, the communication unit 91 transmits, for example, the application ID acquired by the acquisition unit 94 in response to the received application acquisition request to the device 10 through the communication network 5.

The application management unit 92 is a function implemented by instructions of the CPU 901 illustrated in FIG. 3 and manages information about the external application published in the network system 1. The application management unit 92 manages usage status such as the number of installed external applications by using. for example, an application management DB 9001. The determination unit 93 is a function implemented by instructions of the CPU 901 illustrated in FIG. 3 and performs various determinations.

The acquisition unit 94 is a function implemented by instructions of the CPU 901 illustrated in FIG. 3 and acquires information about the external application to be installed in the device 10. The acquisition unit 94 acquires, for example, an application ID that identifies the external application to be installed in the device 10 from the application management DB 9001 in response to the application acquisition request transmitted from the device 10.

The storage/reading unit 99 is implemented by instructions of the CPU 901 illustrated in FIG. 3 and stores various data in the storage unit 9000 and reads various data from the storage unit 9000.

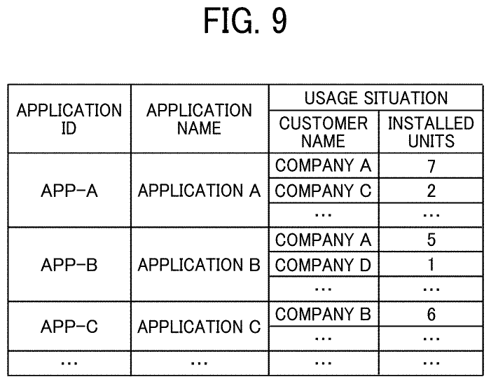

FIG. 9 is a conceptual diagram illustrating an example of the application management table according to the present embodiment. In the storage unit 9000, the application management DB 9001 storing the application management table as illustrated in FIG. 9 is implemented. In the application management table, application information, which is information about the external application published in the network system 1, is stored. The usage status of the external application is associated with the application information for each application ID and application name that identifies the external application. The usage status of external application indicates the number of installations of each external application for each customer.

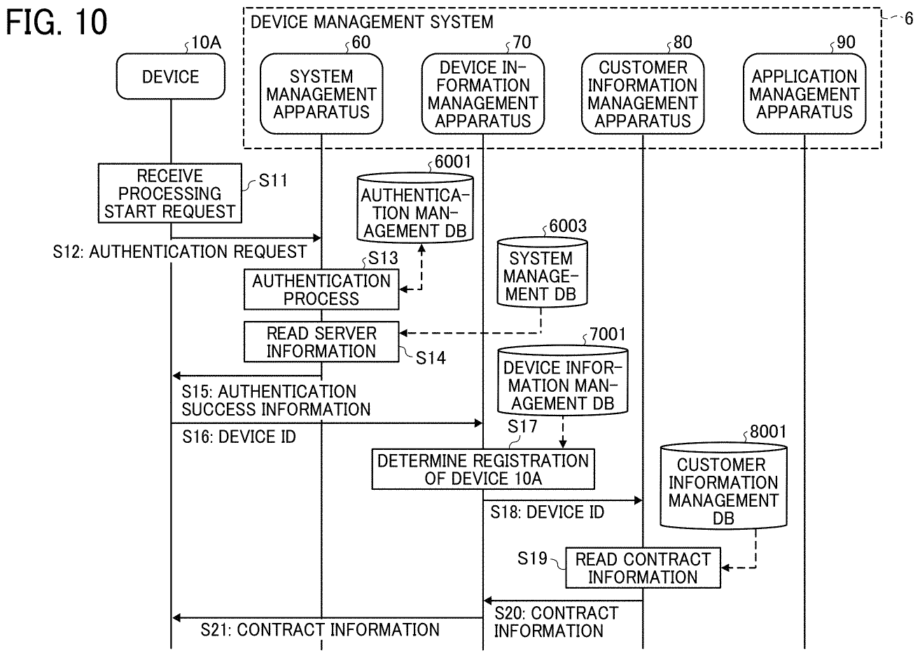

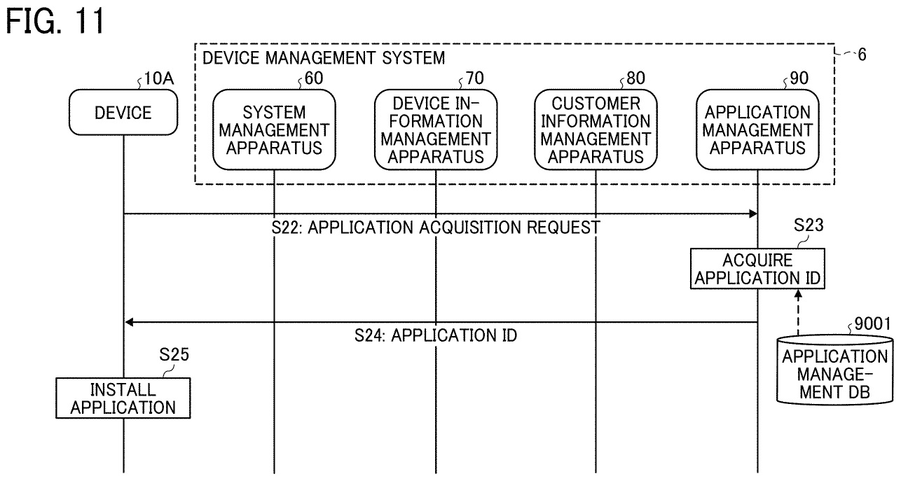

A process executed by the network system according to the present embodiment is described with reference to FIGS. 10 to 14. First, a process of installing the external application on the device 10A when the device 10A is registered in the device management system 6 is described with reference to FIGS. 10 and 11. FIGS. 10 and 11 are sequence diagrams illustrating an example of an installation process of the external application when the device is registered in the network system according to the present embodiment. The installation process for the device 10A is described as an example, but the same process may be executed for other devices.

In step S11, the device 10A receives a process start request indicating to start the process using the cloud integration application 170. Specifically, the reception unit 12 of the device 10A receives the processing start request by the cloud integration application 170 by receiving a user operation. Further, the device 10A may be configured to accept the process start request triggered by the device 10A being connected to the communication network 5.

In step S12, the communication unit 11 of the device 10A sends an authentication request for processing using the cloud integration application 170 of the device 10A to the system management apparatus 60 included in the device management system 6 through the communication network 5. The authentication request includes a device ID and a password for identifying the device 10A. The device ID is an example of device identification information. The communication unit 61 of the system management apparatus 60 receives the authentication request transmitted from the device 10A through the communication network 5.

In step S13, the authentication unit 62 of the system management apparatus 60 searches the authentication management table (see FIG. 7A) using the device ID and password received in step S12 as search keys and permits the authentication (login) of the device 10A when a combination of the received device ID and password is managed in the authentication management table. When the combination of the device ID and the password included in the authentication request is managed in the authentication management table, the process after step S14 is executed.

When the authentication (login) of the device 10A is permitted, the storage/reading unit 69 reads the server information stored in the system management table (see FIG. 7B) in step S14. The storage/reading unit 69 reads the destination information of the device information management apparatus 70, the customer information management apparatus 80, and the application management apparatus 90 illustrated in FIG. 79 as the server information. In step S15, the communication unit 61 transmits an authentication success notification indicating the authentication result in step S13 to the device 10A, which is the source of the authentication request, through the communication network 5. The authentication success notification includes the server information read in step S14. As a result, the communication unit 11 of the device 10A receives the authentication success notification transmitted from the system management apparatus 60 through the communication network 5.

When the communication unit 11 of the device 10A receives the authentication success notification in step S15, the device ID of the device 10A is transmitted to the device information management apparatus 70 included in the device management system 6 through the communication network 5 in step S16. Here, the communication unit 11 transmits the device ID to the destination information of the device information management apparatus 70 included in the authentication success notification received in step S15. As a result, the communication unit 71 of the device information management apparatus 70 receives the device ID transmitted from the device 10A through the communication network 5.

In step S17, the determination unit 73 of the device information management apparatus 70 determines whether the device 10A corresponding to the device ID received in step S16 is registered in the device management system 6. Specifically, the determination unit 73 determines whether the tenant information associated with the device ID of the device 10A is registered with reference to the device information management table (see FIG. SA) in step S17. When the tenant information is indicated in the device information management table, the determination unit 73 determines that the device 10A is registered. On the other hand, the determination unit 73 determines that the device 10A is not registered when “Unregistered” is indicated in the device information management table. Here, a case when the device 10A is registered in the device management system 6 is described.

In step S18, the communication unit 71 of the device information management apparatus 70 transmits the device ID received in step S16 to the customer information management apparatus 80 in order to acquire the contract information of the device 10A. As a result, the communication unit 81 of the customer information management apparatus 80 receives the device ID transmitted from the device information management apparatus 70.

In step S19, the storage/reading unit 89 of the customer information management apparatus 80 searches the customer information management table (see FIG. 89) using the device ID received in step S18 as a search key, and reads the customer's contract information associated with the device ID. The contract information includes the customer name, the tenant information, and the license information. For example, in the customer information management table illustrated in FIG, 89, when the device ID (ULM) “YYY-ZZZ” is received, the storage/reading unit 89 reads the contract information including the name “Company A”. tenant information “Tenant 1” and license information “App-A 10 Licenses, App-B 5 Licenses”.

In step S20, the communication unit 81 transmits the contract information of the device 10A read in step S19 to the device information management apparatus 70. As a result, the communication unit 71 of the device information management apparatus 70 receives the contract information of the device 10A transmitted from the customer information management apparatus 80. In step S21, the communication unit 71 of the device information management apparatus 70 transmits the contract information of the device 10A received in step S20 to the device 10A through the communication network 5. As a result, the communication unit 11 of the device 10A receives the contract information transmitted from the device information management apparatus 70 through the communication network 5.

In FIG. 11, the communication unit 11 of the device 10A transmits an application acquisition request indicating a request for the information of the external application to be installed to the application management apparatus 90 through the communication network 5 in step S22. The application acquisition request includes the license information included in the contract information received in step S21. As a result, the communication unit 91 of the application management apparatus 90 receives the application acquisition request transmitted from the device 10A through the communication network 5.

In step S23, the acquisition unit 94 of the application management apparatus 90 refers to the application management table (see FIG. 9) and acquires an application ID that identifies the external application to be installed on the device 10A. Specifically, the acquisition unit 94 identifies the contracted external application of the customer of the device 10A based on the license information included in the application acquisition request received in step S22. Then, the acquisition unit 94 refers to the usage status of the external application illustrated in the application management table and acquires the application ID of the newly installable external application. The acquisition unit 94 acquires, for example, the application ID of the external application that has not reached the upper limit of the number of licenses to which the number of installations of the external application is granted. The application ID is an example of application identification information.

In step S24, the communication unit 91 transmits the application ID acquired in step S23 to the device 10A through the communication network 5. The communication unit 91 transmits the application IDs “App-A” and “App-B” acquired by the acquisition unit 94 to the device 10A. As a result, the communication unit 11 of the device 10A receives the application ID transmitted from the application management apparatus 90 through the communication network 5.

In step S25, the installation unit 16 of the device 10A installs the external application corresponding to the application ID received by the communication unit 11. Specifically, the installation unit 16 installs the application A and the application B corresponding to the application IDs “App-A” and “App-B” received. by the communication unit 11 on the cloud integration application 170.

As a result, the network system 1 does not require the operator to manually register the customer's tenant information when setting the device 10A, and. by connecting the device 10.A to the communication network 5, the contracted application is automatically installed on the device 10A. Further, the network system 1 can make the device 10A automatically identify the contracted application by notifying the device 10A of the contract information from the device management system 6.

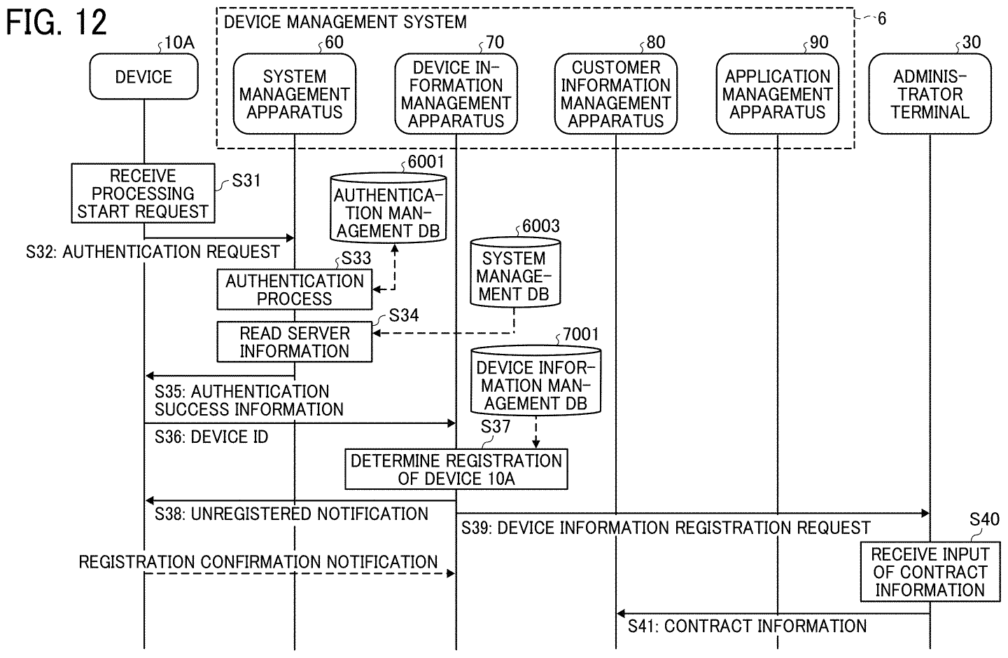

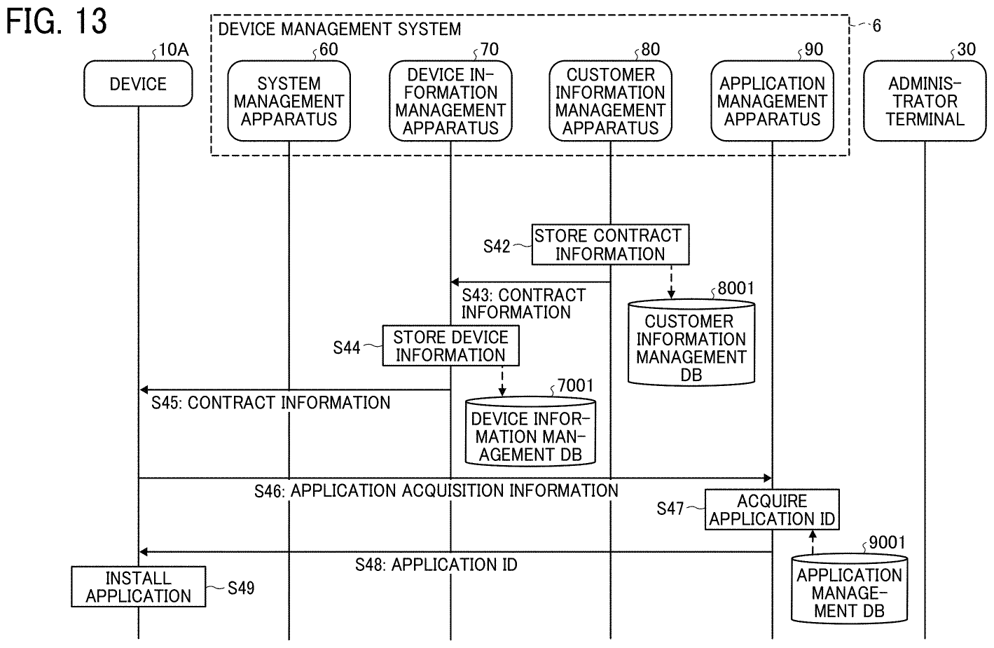

A process of installing the external application on the device 10A when the device 10A is not registered in the device management system 6 is described with reference to FIGS. 12 and 13. FIGS. 12 and 13 are sequence diagrams illustrating an example of the installation process of the external application when the device is not registered in the network system, according to the present embodiments. The installation process for the device 10A is described as an example of the device 10, but the same process may be executed for other devices. Note that the processing of steps S31 to S36 is the same as the processing of steps S11 to S16 illustrated in FIGS. 10 and 11, and description thereof is omitted.

In step S37, the determination unit 73 of the device information management apparatus 70 determines whether the device 10A corresponding to the device ID received in step S36 is registered in the device management system 6. The process executed by the determination unit 73 in step S37 is the same as the process of step S17 illustrated in FIG. 10. Here, a case when the device 10A is not registered in the device management system 6 is described. In step S38, the communication unit 71 transmits an unregistered notification indicating that the device 10A is not registered to the device 10A through the communication network 5. The communication unit 11 of the device 10A receives the unregistered notification transmitted from the device information management apparatus 70 through the communication network 5. Further, the communication unit 11 of the device 10A periodically transmits a registration status confirmation notification to the device information management apparatus 70 in order to confirm the registration status of the device 10A.

In step S39, the communication unit 71 of the device information management apparatus 70 transmits a device information registration request indicating that the device 10A corresponding to the device ID received in step S36 is requested to be registered to the administrator terminal 30 through the communication network 5. The device information registration request includes the device ID of the device 10A. The communication unit 31 of the administrator terminal 30 receives the device information registration request transmitted from the device information management apparatus 70 through the communication network 5.

In step S40, the reception unit 32 of the administrator terminal 30 receives the input of the contract information of the device 10A corresponding to the device ID received by the communication unit 31 by the input operation of the administrator of the network system 1 using the administrator terminal 30. In step S41, the communication unit 31 transmits the contract information received by the reception unit 32 to the customer information management apparatus 80 through the communication network 5.

In step S42 illustrated in FIG. 13, the customer information management unit 82 of the customer information management apparatus 80 stores the contract information received by the communication unit 81 in the customer information management DB 8001 (see FIG. 8B). In step S43, the communication unit 81 transmits the contract information received by the communication unit 81 to the device information management apparatus 70. As a result, the communication unit 71 of the device information management apparatus 70 receives the contract information transmitted from the customer information management apparatus 80.

In step S44, the device information management unit 72 of the device information management apparatus 70 stores the device information included in the contract information received by the communication unit 71 in the device information management DB 7001 (see FIG. 8A). In step S45, the communication unit 71 transmits the contract information received in step S43 to the device 10A through the communication network 5. As a result, the communication unit 11 of the device 10A receives the contract information transmitted from the device information management apparatus 70.

In step S46, the communication unit 11 of the device 10A transmits an application acquisition request indicating that the information of the external application to be installed is requested to the application management apparatus 90 through the communication network 5. The application acquisition request includes the license information included in the contract information received in step S21. As a result, the communication unit 91 of the application management apparatus 90 receives the application acquisition request transmitted from the device 10A through the communication network 5.

In step S47, the acquisition unit 94 of the application management apparatus 90 refers to the application management table (see FIG. 9) and acquires an application ID that identifies the external application to be installed on the device 10A. Specifically, the acquisition unit 94 identifies the contracted external application of the customer of the device 10A based on the license information included in the application acquisition request received in step S46. Then, the acquisition unit 94 refers to the usage status of the external application stored in the application management table and acquires the application ID of the newly installable external application. The acquisition unit 94 acquires, for example, the application ID of the external application that has not reached the upper limit of the number of licenses to which the number of installations of the external application is granted.

In step S48, the communication unit 91 transmits the application ID acquired in step S47 to the device 10A through the communication network 5. The communication unit 91 transmits the application IDs “App-A” and “App-B” acquired by the acquisition unit 94 to the device 10A. As a result, the communication unit 11 of the device 10A receives the application ID transmitted from the application management apparatus 90 through the communication network 5.

In step S49, the installation unit 16 of the device 10A installs the external application corresponding to the application ID received by the communication unit 11. Specifically, the installation unit 16 installs the application A and the application B corresponding to the application IDs “App-A” and “App-B” received by the communication unit 11 on the cloud integration application 170.

As a result, in the network system 1, when the device 10A is not registered in the device management system 6, the external application according to the contract details of the device 10A is automatically installed by notifying the device 10A of the contract information after the registration is completed.

As described above, the network system 1 manages the device ID transmitted from the device 10 and the contract information indicating the purchase history of the device 10 and the external application in association with the device management system 6 on the cloud. Then, the network system 1 causes the device 10 to install the external application identified based on the tenant information included in the contract information. As a result, the network system 1 does not require the operator to manually register the device 10 in the customer's tenant when installing the device 10 since the contracted external application is automatically installed on the device 10, and it is possible to reduce the cost and workload required when installing the device or installing the external application.

As described above, the device management system according to the embodiment of the present disclosure is a device management system 6 that manages the device 10 through the communication network 5. The device management system 2 0 receives the device ID (an example of device identification information) for identifying the device 10 transmitted from the device 10 and transmits the application ID (example of application identification information) for identifying the external application (example of application) identified based on the tenant information associated with the received device ID to the device 10. Then, the device management system 6 causes the device 10 to install the external application identified by the transmitted application ID. As a result, the device management system 6 does not require the operator to manually register the customer's tenant information when setting the device 10, and by connecting the device 10 to the communication network 5, the contracted external application is automatically installed in the device 10. Therefore, the device management system 6 can reduce the workload when installing the desired external application on the device 10.

Further, the device management system according to the embodiment of the present disclosure determines whether the tenant information indicating the tenant corresponding to the device 10 identified by the received device ID (an example of the device identification information) is registered in the device management system 6 and when tenant information is registered, the application ID (example of application identification information) that identifies the external application (example of application) identified based on the tenant information associated with the received device ID is transferred to the device 10. As a result, the device management system 6 manages the device ID and the tenant information assigned to the customer who owns the device 10 in association with each other, thereby identifying the external application associated with the tenant information as the application to be installed.

Further, when the tenant information is not registered, the device management system according to the embodiment of the present disclosure transmits a request for acquiring the contract information of the device 10 identified by the received device ID (an example of the device identification information) to the administrator terminal 30 used by the administrator of the device 10, acquires the tenant information according to the contract information sent from the administrator terminal 30, and registers the acquired tenant information in the device information management DB 7001 (an example of the device information storage unit). As a result, the device management system 6 automatically installs the external application according to the customer's contract details on the device 10 by notifying the device 10 of the contract information after the registration is completed even when the device 10 is not registered.

Further, the device management system according to the embodiment of the present disclosure stores the contract information indicating the contract details for each customer who uses the device 10 in the customer information management DB 8001 (an example of the customer information storage unit) and the information of the external application (an example of the application) to be installed on the device 10 in the application management DB 9001 (an example of the application storage unit). Then, the device management system 6 transmits the application ID (an example of application identification information) corresponding to the external application stored in the application management DB 9001 according to the license for each tenant included in the tenant information included in the contract information to the device 10. As a result, by managing the device ID and the contract information such as the purchase history of the external application in association with each other, the device management system 6 registers the device 10 in the customer's tenant when installing the device 10, and the contracted external application is automatically installed in the device 10.

Further, the device management system according to the embodiment of the present disclosure transmits the contract information corresponding to the received device ID (an example of the device identification information) to the device 10 and receives from the device 10, a request for acquiring information of the external application (an example of an application) to be installed indicated in the transmitted contract information. Then, the device management system 6 acquires the application ID (an example of application identification information) from the application management DB 9001 and transmits the acquired application ID to the device 10, based on the received acquisition request and the usage status of the external application stored in the application management DB 9001 (an example of the application storage unit). As a result, the device management system 6 can automatically identify the contracted external application of the device 10 by notifying the device 10 of the contract information.

Further, the network system according to the embodiment of the present disclosure is the network system 1 including the device management system 6 and the device 10. In the network system 1, the device 10 transmits a device ID (an example of device identification information) that identifies the device 10 to the device management system 6, receives the application ID (example of application identification information) transmitted from the device management system 6, and. installs the external application (example of application) identified by the received application ID. As a result, the network system 1 does not require the operator to manually register the customer's tenant information when setting the device 10, and by connecting the device 10 to the communication network 5, the contracted external application is automatically installed in the device 10. Therefore, the network system 1 can reduce the workload when installing the desired external application on the device 10.

Any one of the above-described control programs may be recorded in a file in a format installable or executable on a computer-readable storage medium for distribution. Examples of the storage medium include, but not limited to, Compact Disc Recordable (CD-R), Digital Versatile Disc (DVD), Blu-ray (registered trade mark) disc, Secure Digital (SD) card, Universal Serial Bus (USB) memory, and the like. In addition, such storage medium may be provided in the form of a program product to users within a certain country or outside that country. For example, the device management system 6 including the system management apparatus 60, the device information management apparatus 70, the customer information management apparatus 80, and the application management apparatus 90 implements the device management method according to the present disclosure by executing the program according to the present disclosure.

Various tables of the embodiments described above may be generated by the learning effect of machine learning, and by classifying the data of each related item by machine learning, the tables may not be used. In the present disclosure, machine learning is a technique that enables a computer to acquire human-like learning ability. Machine learning refers to a technology in which a computer autonomously generates an algorithm required for determination such as data identification from learning data loaded in advance and applies the generated algorithm to new data to make a prediction. Any suitable learning method is applied for machine learning, for example, any one of supervised learning, unsupervised learning, semi-supervised learning, reinforcement learning, and deep learning, or a combination of two or more those learning.

The device management system, the network system, the device management method, and the program according to the embodiment of the present disclosure have been described above. The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

According to one aspect, the present disclosure may reside in a method comprising receiving device identification information for identifying a device transmitted from the device through a communication network, acquiring application identification information for identifying an application identified based on tenant information associated with the received device identification information, and transmitting the application identification information to the device as identification information of the application to be installed on the device.

What is claimed is:

1. A device management system comprising one or more computers, the device management system comprising:
circuitry configured to;
receive device identification information for identifying a device transmitted from the device through a communication network;
acquire application identification information for identifying an application identified based on tenant information associated with the received device identification information; and
transmit the application identification information to the device as identification information of the application to be installed on the device.

2. The device management system of claim I, wherein the circuitry is further configured to:
determine whether the tenant information indicating a tenant corresponding to the device identified by the received device identification information is registered in the device management system; and
when the tenant information is registered in the device management system, transmit the application identification information to the device.

3. The device management system of claim 2, further comprising:
one or more memories that store, for one or more devices, device identification information and tenant information in association with each other in a memory, and
wherein when the tenant information associated with the received device identification information is stored in the memories, the circuitry determines that the tenant information is registered in the device management system.

4. The device management system of claim 3, wherein when the tenant information is not registered, the circuitry is further configured to:
transmit a request for acquiring contract information of the device identified by the received device identification information to an administrator terminal used by an administrator of the device;
acquire the tenant information according to the contract information transmitted from the administrator terminal; and
store the acquired tenant information in the memories in association with the received device identification information.

5. The device management system of claim I, further comprising: one or memories that store contract information indicating details of contracts for each customer using the device, and
store information on the application to be installed on the device , wherein the circuitry transmits the application identification information corresponding to the application stored in the memory to the device according to license for each tenant, indicated in the tenant information included in the contract information.

6. The device management system of claim 5, wherein the circuitry is further configured to:
transmit the contract information corresponding to the received device identification information to the device;
receive a request for acquiring information for identifying the application indicated in the contract information from the device;
acquire the application identification information from the one or more memories based on the received acquisition request and information regarding usage status of the application stored in the memory; and
transmit the acquired application identification information to the device.

7. The device management system of claim 1, wherein the circuitry is further configured to:
authenticate the device; and
receive the device identification information from the authenticated device.

8. A network system comprising:
the device management system of claim 1; and
the device, wherein the device comprises circuitry configured to:
transmit the device identification information for identifying the device to the device management system;
receive the application identification information transmitted from the device management system; and
install the application identified by the received application identification information.

9. A device management apparatus comprising:
circuitry configured to;
receive, from a device through a communication network, device identification information for identifying the device;
acquire application identification information for identifying an application identified based on tenant information associated with the received device identification information; and
transmit the application identification information to the device as identification information of the application to be installed on the device.

10. The device management apparatus of claim 9, wherein the circuitry is further configured to:
determine whether the tenant information indicating a tenant corresponding to the device identified by the received device identification information is registered in the device management apparatus; and
when the tenant information is registered in the device management apparatus, transmit the application identification information to the device.

11. The device management apparatus of claim 10, wherein the circuitry is further configured to:
store, for one or more devices, device identification information and tenant information in association with each other in one or memories; and
when the tenant information associated with the received device identification information is stored in the memories, determine that the tenant information is registered in the device management apparatus.

12. The device management apparatus of claim 11, wherein when the tenant information is not registered, the circuitry is further configured to:
transmit a request for acquiring contract information of the device identified by the received device identification information to an administrator terminal used by an administrator of the device;
acquire the tenant information according to the contract information transmitted. from the administrator terminal; and
store the acquired tenant information in the memories in association with the received device identification information.

13. The device management apparatus of claim 9, wherein the circuitry is further configured to:
store contract information indicating details of contracts for each customer using the device in the memories;
store information about the application to be installed on the device in the memories; and
transmit the application identification information corresponding to the application stored in the memory to the device according to license for each tenant, indicated in the tenant information included in the contract information.

14. The device management apparatus of claim 13, wherein the circuitry is further configured to:
transmit the contract information corresponding to the received device identification information to the device;
receive a request for acquiring information for identifying the application indicated in the contract information from the device;
acquire the application identification information from the memory based on the received acquisition request and information regarding usage status of the application stored in the one or more memories; and transmit the acquired application identification information to the device.

15. The device management apparatus of claim 9, wherein the circuitry is further configured to:
authenticate the device; and
receive the device identification information from the authenticated device.

16. A network system comprising:
first circuitry residing on a device management system and second circuitry residing on a device, the first circuitry and the second circuitry being configured to cooperate with each other to:
acquire device identification information for identifying the device, in response to receiving a request to start cooperative processing between the device and the device management system;
acquire application identification information that identifies an application identified based on tenant information associated with the device identification information; and
install the application identified by the application identification information on the device.
